(19) United States
(12) Patent Application Publication
(10) Pub. No.: US 2005/0104029 A1
(43) Pub. Date: May 19, 2005

(54) Use of paraffin-containing powders as phase-change materials (pcm) in polymer composites in cooling devices

(76) Inventor: Mark Neuschuetz, Darmstadt (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/500,818

(22) PCT Filed: Dec. 13, 2002
(86) PCT No.: PCT/EP02/14180

(30) Foreign Application Priority Data
Jan. 7, 2002 (DE) 102 00 318.1

(51) Int. Cl. C09K 3/18

(52) U.S. Cl. 252/70

(57) ABSTRACT

The invention relates to polymer composites comprising phase-change materials and to their use in devices for cooling, in particular, electrical and electronic components.

The present invention relates to polymer composites comprising phase-change materials and to the use thereof in cooling devices, in particular for electrical and electronic components.

In industrial processes, heat peaks or deficits often have to be avoided, i.e. temperature control must be provided. This is usually achieved using heat exchangers. In the simplest case, they may consist merely of a heat conduction plate, which dissipates the heat and releases it to the ambient air, or alternatively contain heat transfer media, which firstly transport the heat from one location or medium to another.

The state of the art for the cooling of electronic components, such as, for example, microprocessors (central processing units=CPUs), are heat sinks made from extruded aluminium, which absorb the heat from the electronic component, which is mounted on a support, and release it to the environment via cooling fins. The convection at the cooling fins is generally supported by fans.

Heat sinks of this type must always be designed for the most unfavourable case of high outside temperatures and full load of the component in order to prevent over-heating, which would reduce the service life and reliability of the component. The maximum working temperature for CPUs is between 60 and 90° C., depending on the design.

As the clock speed of CPUs becomes ever faster, the amount of heat they emit jumps with each new generation. While hitherto it has been necessary to dissipate peak output power levels of a maximum of 30 watts, it is expected that in the next 8 to 12 months cooling capacities of up to 90 watts will be necessary. These out-put power levels can no longer be dissipated using conventional cooling systems.

For extreme ambient conditions, as occur, for example, in guided missiles, heat sinks, in which the heat emitted by electronic components is absorbed in phase-change materials, for example in the form of heat of melting, have been described (U.S. Pat. No. 4,673,030A, EP 116503A, U.S. Pat. No. 4,446,916A). These PCM heat sinks serve for short-term replacement of dissipation of the energy into the environment and can-not (and must not) be re-used.

Known storage media are, for example, water or stones/concrete for the storage of sensible heat or phase-change materials (PCMs), such as salts, salt hydrates or mixtures thereof, or organic compounds (for example paraffin) for the storage of heat in the form of heat of melting (latent heat).

It is known that when a substance melts, i.e. is converted from the solid phase into the liquid phase, heat is consumed, i.e. absorbed, and is stored as latent heat so long as the substance remains in the liquid state, and that this latent heat is liberated again on solidification, i.e. on conversion from the liquid phase into the solid phase.

The charging of a heat-storage system basically requires a higher temperature than can be obtained during discharging, since a temperature difference is necessary for the transport or flow of heat. The quality of the heat is dependent on the temperature at which it is available again: the higher the temperature, the better the heat can be dissipated. For this reason, it is desirable for the temperature level during storage to drop as little as possible.

In the case of the storage of sensible heat (for example by heating water), the input of heat is associated with constant heating of the storage material (and the opposite during discharging), while latent heat is only stored and discharged at the phase-transition temperature of the PCM. Latent heat-storage therefore has the advantage over sensible heat storage that the temperature loss is restricted to the loss during heat transport from and to the storage system.

The storage media employed hitherto in latent heat-storage systems are usually substances which have a solid-liquid phase transition in the temperature range which is essential for the use, i.e. substances which melt during use.

Thus, the literature discloses the use of paraffins as storage medium in latent heat-storage systems. International patent application WO 93/15625 describes shoe soles which contain PCM-containing microcapsules. The application WO 93/24241 describes fabrics having a coating comprising microcapsules of this type and binders. The PCMs employed here are preferably paraffinic hydrocarbons having from 13 to 28 carbon atoms. European Patent EP-B-306 202 describes fibres having heat-storage properties in which the storage medium is a paraffinic hydrocarbon or a crystalline plastic, and the storage material is integrated into the basic fibre material in the form of microcapsules.

WO 96/39473 describes building materials having thermal energy-storing properties which comprise paraffins in hydrophobic silica. The hydrophobicisation is achieved, for example, by coating the silica with silanes or silicones. Salyer et al. have described in numerous protective rights that paraffin-impregnated, hydrophobicised silica or kieselguhr only bleeds a little, or not at all, if the paraffin melts.

DE 100 27 803 proposes buffering the output power peaks of an electrical or electronic component with the aid of phase-change materials (PCMs), where the device for cooling heat-generating electrical and electronic components having an irregular power profile essentially consists of a heat-conducting unit and a heat-absorbing unit containing a phase-change material (PCM). The PCMs here are installed in the heat sink in various ways. The requisite physical modifications to the heat sinks make the product considerably more expensive. In addition, heat transfer from the heat-releasing unit to the PCM is unsatisfactory.

The object of the present invention is to optimise the heat transfer from a heat-releasing unit to PCMs and to provide a cooling system for electronic components which is distinguished by high availability, low price, toxicological acceptability and simple manufacture.

This object is achieved by polymer composites comprising polymers and a silica matrix in which PCMs are embedded, and by a device for cooling heat-generating components having an irregular power profile, essentially consisting of a heat-dissipating unit (1) and a heat-absorbing unit (4), which contains at least one polymer composite according to the main claim.

Surprisingly, it has been found that particularly good heat transfer from the heat-dissipating unit (1) to the heat-absorbing unit (4) occurs if the PCMs embedded in a silica matrix are incorporated into polymers.

The use of polymers has proven particularly advantageous since they remain elastic in spite of temperature variations. This establishes good long-term contact between the heat-releasing and heat-absorbing units.

The good processing properties of the polymers are also advantageous. In the uncured state, the polymers can easily be converted into the prescribed shape. The polymers likewise effect good wetting of the respective surface.

The present invention relates, in particular, to devices for cooling electrical and electronic components which have an irregular output power profile, such as, for example, memory chips or microprocessors (MPUs=microprocessing units) in desktop or laptop computers, both on the motherboard and on graphics cards, power supplies and other electronic components which emit heat during operation.

These types of cooling with the aid of PCMs to even out heat peaks are, however, not restricted to use in computers. The systems according to the invention can be used in all devices which have output power variations and in which heat peaks are to be evened out since overheating can cause possible defects to occur. Examples thereof, which do not restrict generality, are power circuits and power switching circuits for mobile communications, transmitter circuits for mobile telephones and fixed transmitters, control circuits for electromechanical actuating elements in industrial electronics and in motor vehicles, high-frequency circuits for satellite communications and radar applications, single-board computers and for actuating elements and control units for domestic appliances and industrial electronics. The cooling devices according to the invention may furthermore also be used, for example, in motors for elevators, sub-stations or internal-combustion engines.

Cooling devices according to the invention are, for example, heat sinks. The use of PCMs in the manner according to the invention enables the use of conventional cooling devices of lower cooling efficiency since the extreme heat peaks do not have to be dissipated, but are instead buffered.

The heat flow from heat-generating component to heat sink should not be interrupted, i.e. the heat should flow firstly through the heat-dissipating unit, for example the heat sink, and not to the PCM. An interruption in this sense exists if the PCMs, owing to the design of the heat sink, firstly have to absorb the heat before the heat can be dissipated via the cooling fins—which results in an impairment of the performance of the heat sink for a given design.

In order to ensure that the PCMs only absorb the output power peaks, the PCMs are therefore preferably arranged in or on the cooling device in such a way that the classical cooling efficiency of the heat-dissipating unit is if at all possible not impaired and that a significant heat flow to the PCM only occurs if the heat-dissipating unit exceeds the phase change temperature T_{PC} of the respective PCM. Before this point in time, only a small amount of heat such as is absorbed during normal temperature increases of the environment flows into the PCM. If, however, T_{PC} is reached, further cooling takes place (i.e. dissipation of the heat) through the heat-dissipating unit and in addition an increased heat flow to the PCM occurs.

Improved heat transfer from the heat-dissipating unit to the heat-absorbing unit is achieved by the good adhesion of the polymer to the metal.

Depending on the critical maximum temperature determined by the heat-generating component, all known PCMs are suitable. Various PCMs are available for the device according to the invention. It is in principle possible to use PCMs whose phase-change temperature is between −100° C. and 150° C. For use in electrical and electronic components, PCMs in the range from ambient temperature to 95° C. are preferred. The materials here can be selected from the group consisting of paraffins (C₂₀-C₄₅), inorganic salts, salt hydrates and mixtures thereof, carboxylic acids or sugar alcohols. A non-restrictive selection is shown in Table 1.

TABLE 1

| | Melting point | Enthalpy of | |
|---|---|---|---|
| Material | [° C.] | melting [J/g] | Group |
| Heneicosane | 40 | 213 | Paraffins |
| Docosane | 44 | 252 | Paraffins |
| Tricosane | 48 | 234 | Paraffins |
| Sodium thiosulfate | 48 | 210 | Salt hydrates |
| pentahydrate | | | |
| Myristic acid | 52 | 190 | Carboxylic acids |
| Tetracosane | 53 | 255 | Paraffins |
| Hexacosane | 56 | 250 | Paraffins |
| Sodium acetate | 58 | 265 | Salt hydrates |
| trihydrate | | | |
| Nonacosane | 63 | 239 | Paraffins |
| Sodium hydroxide | 64 | 272 | Salt hydrates |
| monohydrate | | | |
| Stearic acid | 69 | 200 | Carboxylic acids |
| Mixture of lithium | 75 | 180 | Salt hydrates |
| nitrate, magnesium | | | |
| nitrate hexahydrate | | | |
| Trisodium phosphate | 75 | 216 | Salt hydrates |
| dodecahydrate | | | |
| Magnesium nitrate | 89 | 160 | Salt hydrates |
| hexahydrate | | | |
| Xylitol | 93-95 | 270 | Sugar alcohols |

Paraffins are particularly suitable. In the case of solid/liquid PCMs, it is necessary to prevent the leaking of these materials. Suitable as matrix for the PCMs here are, in particular, polymers, graphite, for example expanded graphite, or porous inorganic substances, such as, for example, silica. Preference is given to the use of a hydrophobicised silica. The experiments were carried out using a hydrophobicised silica of the “XI 50” type from Rubitherm, which comprises paraffins which melt at 50-55° C. The particles of this material have a diameter of about 100 μm and are virtually spherical. This shape is particularly favourable for incorporation into a polymer matrix since the volume/surface area ratio is large and the amount of polymer necessary for wetting is small.

In a preferred embodiment, the polymer composites optionally comprise an auxiliary in addition to the actual heat-storage material. The heat-storage material and the auxiliary are in the form of a mixture, preferably an intimate mixture.

The auxiliary is preferably a substance or preparation having good thermal conductivity, in particular a metal powder or metal granules (for example aluminium or copper) or graphite. These auxiliaries ensure good heat transfer.

In accordance with the invention, the phase-change materials in the silica matrix are introduced into polymers. During use, the polymers establish intimate contact, i.e. good wetting, between the heat-storage medium and the surface of the heat-dissipating unit. For example, latent heat-storage systems can be installed with an accurate fit for cooling electronic components. The polymer expels air at the contact surfaces, thus ensuring close contact between heat-storage material and the heat-dissipating unit. Media of this type are therefore preferably used in devices for cooling electronic components.

Polymer composites according to the invention can comprise any polymers which facilitate good wetting of the respective surfaces. The polymers here are preferably a curable polymer or a polymer precursor, in particular selected from the group consisting of polyurethanes, polyesters, nitrile rubber, chloroprene, polyvinyl chloride, silicones, ethylene-vinyl acetate copolymers and polyacrylates. The polymer used is particularly preferably silicone. Suitable methods for incorporation of the heat-storage materials into these polymers are well known to the person skilled in the art in this area. He has no difficulties in finding, where appropriate, the requisite additives which stabilise a mixture of this type.

The polymer composites according to the invention comprise at least one polymer, PCMs in a silica matrix and optionally auxiliaries and/or additives.

The present invention furthermore relates to a device which essentially consists of a heat-dissipating unit (1) and a heat-absorbing unit (4). The heat-dissipating and heat-absorbing units (1) and (4) respectively and the heat-generating unit (2) are arranged in relation to one another in such a way that the heat flow between the heat-generating unit (2) and the heat-dissipating unit (1) takes place in direct contact.

Preference is furthermore given to cooling devices according to the invention whose heat-dissipating unit (1) has structures which increase the surface area. The heat-dissipating unit (1) particularly preferably has cooling fins. Structures of this type have a positive effect on the conventional cooling efficiency, increasing the overall cooling efficiency of the device according to the invention. The heat-dissipating unit (1) preferably furthermore has a fan on the side opposite the heat-generating unit (2) in order to support the cooling efficiency.

The heat-generating unit (2) is preferably an electrical or electronic component, particularly preferably an MPU (microprocessing unit), in particular a CPU (central processing unit), or a memory chip of a computer.

A general example of the invention is explained in greater detail below.

The polymer composite according to the invention comprises suitable polymers as matrix. A multiplicity of polymers is suitable. Suitable polymers are those which are elastic and facilitate good wetting of the surfaces, usually metals, such as aluminium or copper. Particularly suitable materials are those which can be cured on site. Silicones, polyurethanes and polyesters have been found to be particularly suitable.

The PCMs used are preferably paraffins embedded in a silica matrix, preferably in a hydrophobicised silica matrix. Suitable auxiliaries are added to the polymer composites. Preference is given to the addition of substances having good thermal conductivity. Metal powders, metal granules or graphite are particularly suitable.

The proportion of the PCMs in the polymer composites can be between 5 and 95% by weight. If an auxiliary is added in order to improve the thermal conductivity, any desired mixing ratios can be set. Suitable compositions comprise from 5 to 95% by weight of polymers, from 5 to 95% by weight of PCMs and from 5 to 95% by weight of auxiliaries, where the sum is always 100%. Particularly suitable compositions comprise 20-40% by weight of polymers, 40-60% by weight of PCMs (in silica matrix) and 10-30% by weight of auxiliaries for improving the thermal conductivity.

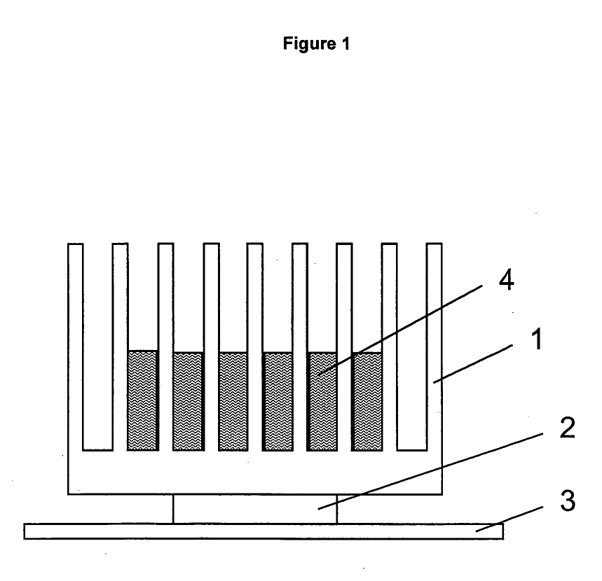

The polymer composites of this composition are employed in the device according to the invention (FIG. 1). The material is applied to the device in such a way that good contact is established between the polymer composites (heat-absorbing unit) and the heat sink (heat-dissipating unit). The polymer composites (4) are arranged on the heat sink (1) in such a way that the heat flow takes place firstly through the heat sink and subsequently through the polymer composites or PCMs, i.e. a significant heat flow from the CPU (2) on the support (3) to the PCMs in the polymer composites (4) only takes place when the corresponding heat-sink regions exceed the phase-change temperature Tpc of the PCM. It is thus ensured that the PCMs in the polymer composites absorb only the output power peaks. Under certain circumstances, the polymer is cured on site by addition of initiators.

TABLE 2
Explanation of the designations in the figure

| Designation | Explanation |
|---|---|
| 1 | cooling fins |
| 2 | central processing unit (CPU) |
| 3 | support |
| 4 | polymer composite comprising phase- |
| | change material or materials (PCM) in a |
| | silica matrix in polymers |

The following examples are intended to explain the invention in greater detail, but without limiting it.

### EXAMPLES

### Example 1

For a processor with a maximum output power of 90 W, a heat sink as shown in FIG. 1 is designed. Use is made of a paraffin in a silica matrix (“XI 50” from Rubitherm) which comprises a paraffin which melts at 50-55° C. A polymer composite is produced from 70% by weight of XI 50 and 30% by weight of silicone. This polymer composite is applied to the heat sink. The cooling efficiency of the heat sink produced in this way is satisfactory.

### Example 2

For a processor with a maximum output power of 90 W, a heat sink as shown in FIG. 1 is designed. Use is made of a paraffin in a silica matrix (“XI 50” from Rubitherm) which comprises a paraffin which melts at 50-55° C. In order to improve the dynamics of the heat sink, heat-conducting additives are added.

A polymer composite is produced from 50% by weight of XI 50, 30% by weight of silicone and 20% by weight of aluminium powder. This polymer composite is applied to the heat sink.

Improved heat absorption and release are observed, which are particularly evident on regeneration of the PCM.

In neither experiment are adverse interactions observed between the PCM and the silicone matrix. In addition, good wetting of the heat-sink surfaces was observed

1. Polymer composites suitable as matrix for phase-change materials (PCMs) for the storage of heat, comprising polymers, a silica matrix in which the PCMs are embedded, and optionally additives and/or auxiliaries.

2. Polymer composites according to claim 1, characterised in that, as PCMs, paraffins are embedded in a silica matrix.

3. Polymer composites according to claim 1, characterised in that the PCMs are embedded in hydrophobicised silica.

4. Polymer composites according to claim 1, characterised in that the PCMs in a silica matrix are incorporated into polymers selected from the group consisting of silicones, polyurethanes and polyesters.

5. Polymer composites according to claim 1, characterised in that auxiliaries are added to the polymers.

6. Polymer according to claim 5, characterised in that the auxiliary is a substance having good thermal conductivity, in particular a metal powder, metal granules or graphite.

7. Device for cooling heat-generating components, essentially consisting of a heat-dissipating unit and a heat-absorbing unit, which contains at least one polymer composite according to claim 1.

8. Device according to claim 7, characterised in that the heat-dissipating unit has structures, in particular cooling fins, which increase the surface area.

9. Device according to claim 7, characterised in that the heat-dissipating unit has a fan for additional cooling.

10. Computer containing polymer composites according to claim 1.

11. Use of polymer composites according to claim 1 in computers and electronic data-processing systems.

12. Use of polymer composites according to claim 1 in power circuits and power switching circuits for mobile communications, transmitter circuits for mobile telephones and fixed transmitters, control circuits for electromechanical actuating elements in industrial electronics and in motor vehicles, high-frequency circuits for satellite communications and radar applications, single-board computers and for actuating elements and control units for domestic appliances and industrial electronics.
